(19) United States
(12) Patent Application Publication
(10) Pub. No.: US 2006/0079974 A1
(43) Pub. Date: Apr. 13, 2006

(54) Memory-based audio player with illumination

(75) Inventor: Wong Hoo Sim, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 10/961,102

(22) Filed: Oct. 8, 2004

(51) Int. Cl. G06F 17/00; H04M 1/22

(52) U.S. Cl. 700/94; 381/124; 362/86

(57) ABSTRACT

A memory-based audio player with illumination comprising a casing and an audio system within the casing. The audio system is able to be powered by an energy source when the energy source is operatively connected to the audio system. At least one light source is mounted to a first wall of the casing and is able to be energized by the energy source when the energy source is located within the audio player. A switch is mounted to the casing for controlling the energization of the light source by the energy source. There is also a rewritable memory for storing digital media tracks. The audio system comprises an audio processor for playing media tracks stored in the rewritable memory; and an output coupled to the audio processor.

### FIELD OF THE INVENTION

This invention relates to a memory-based audio player with illumination refers particularly, though not exclusively, to such an audio player with illumination for illumination of objects external to the audio player.

### BACKGROUND OF THE INVENTION

Memory-based audio players are becoming quite common. Such audio players use a non-volatile memory for recording audio. The non-volatile memory may be one or more of: disks and flash memory. The audio player may operate according to a number of know systems including, for example MP3.

As disk sizes become smaller, and flash memory more available, such audio players are become quite compact. As such, they can easily be carried in a pocket, handbag, briefcase, or the like.

As most people will also have other electronic devices in the pocket, handbag, briefcase, or the like, it is becoming awkward to carry so many electronic devices, and also difficult to find the correct device when needed.

### SUMMARY OF THE INVENTION

According to a first aspect there is provided a memory-based audio player with illumination comprising a casing and an audio system within the casing. The audio system is able to be powered by an energy source when the energy source is operatively connected to the audio system. There is a rewritable memory for storing digital media tracks, and at least one light source mounted to a first wall of the casing. The light source is able to be energized by the energy source when the energy source is operatively connected to the audio system. Also, there is a switch mounted to the casing for controlling the energization of the light source by the energy source. The audio system comprises an audio processor for playing media tracks stored in the rewritable memory; and an audio output coupled to the audio processor.

The switch may be mounted in a second wall of the casing, the first and second walls being different and intersect at an edge. The switch may be adjacent the edge, and may be aligned along the edge with the light source.

The switch may be momentary switch, and the audio player may further comprise an electronic circuit with a latching function. The electronic circuit may further comprise a DC/DC converter for converting a voltage as supplied by the energy source.

The light source may be a light emitting diode, preferably a light emitting diode for emitting white light. The energy source may be a battery located in a compartment within the casing. The audio player may be a portable MP3 player.

### DETAILED DESCRIPTION OF THE DRAWINGS

In order that the invention may be fully understood and readily put into practical effect, there shall now be described by way of non-limitative example only preferred embodiments of the present invention, the description being with the reference to the accompanying illustrative drawings in which:

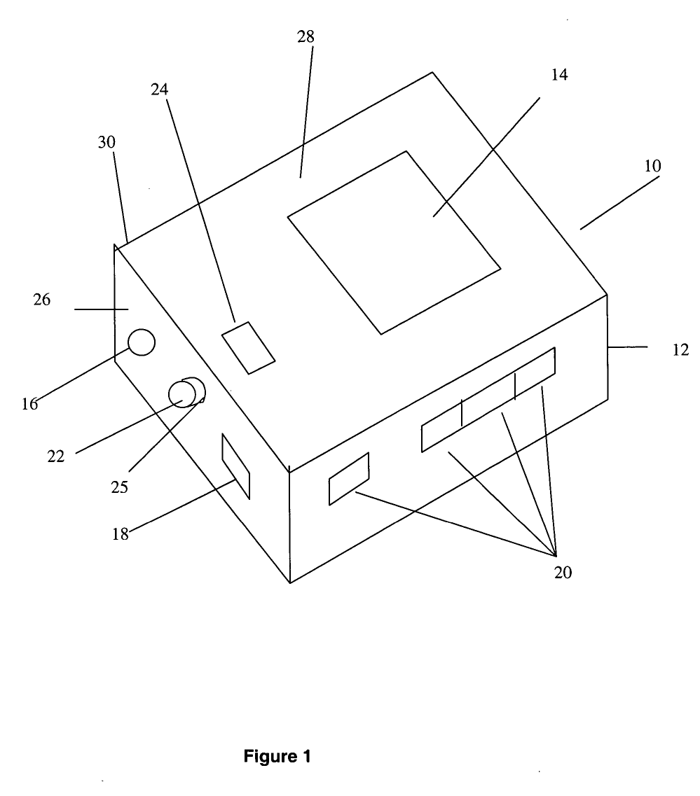

FIG. 1 is a perspective view of the first embodiment of an audio player in accordance with the present invention;

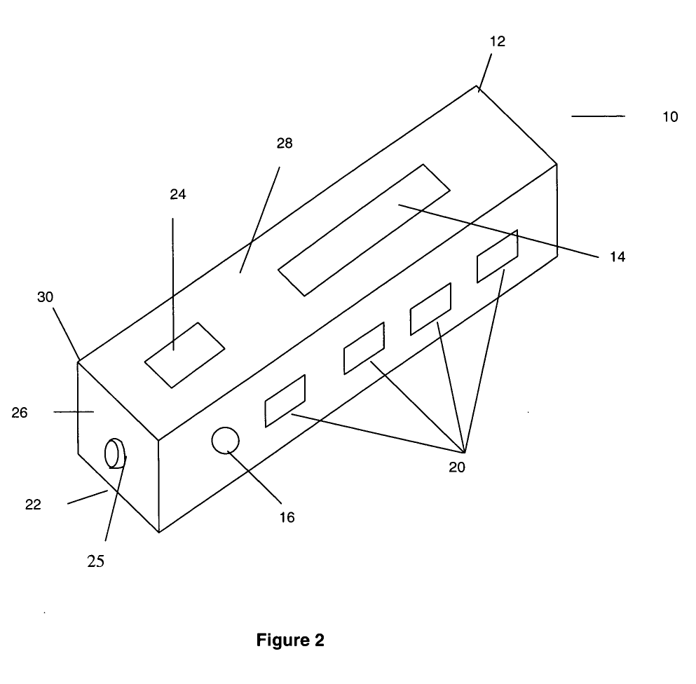

FIG. 2 is perspective view of a second embodiment of a audio player in accordance with the present invention;

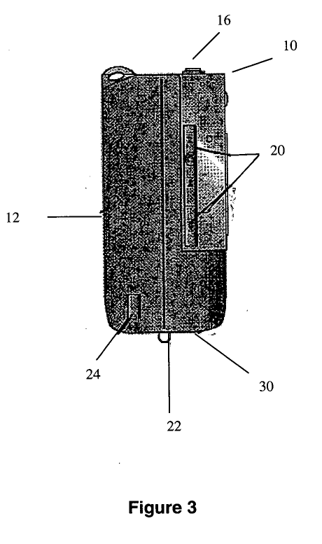

FIG. 3 is a front view of the third embodiment of a audio player in accordance with the present invention; and

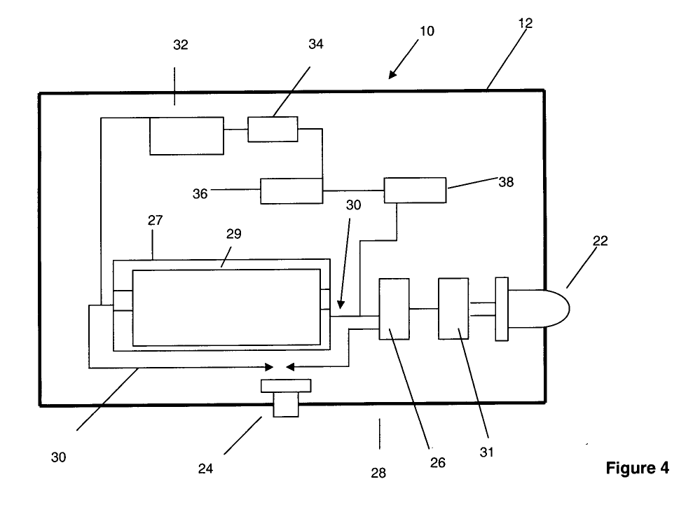

FIG. 4 is block diagram of a preferred circuit for use with the embodiment of FIGS. 1 to 3.

### DETAILED DESCRIPTION OF THE PREFERRED EMBODIMENTS

FIGS. 1 and 2 both show portable audio players such as MP3 players. The player 10 of FIG. 1 is of a well-known form and generally uses disks (not shown) as a non-volatile memory for storage of audio or other data. FIG. 2 is of a well-known form and generally uses flash memory as non-volatile memory for storage of audio or data.

Each player 10 has a casing 12 with a display 14, earphone socket 16, recharging socket 18 (FIG. 1 only) and various control buttons or switches generally indicated as 20.

Mounted in or to an end wall 26 of casing 12 is a light source 22. The light source 22 may be one or more incandescent globes or one or more light emitting diodes. If a light emitting diode, it may be for emitting white light, or any colour including red, yellow, green, blue, and so forth. A light emitting diode is preferred due to its relatively low power consumption. An ultrabright light emitting diode may be used. Although the light source 22 is shown mounted in an opening 25 in the wall 26, it may be mounted in any wall of casing 12. The light source 22 should be exposed to the outer surface of wall 26 but may not project beyond wall 26 so that wall 26 provides a physical protection. Furthermore, opening 25 may provide a constraint on light emission from light source 22 to reduce the included angle of distribution of light emitted from light source 22.

Mounted in front wall 28 of casing 12 is a switch 24 to selectively operate light source 22. The switch 24 may be in any wall of casing 12 including wall 26 in which light source is mounted, but it is preferred that the switch 24 be in a different wall to light source 22. Preferably, the walls 26, 26 in which light source 22 and switch 24 are located respectively intersect at an edge 30. More preferably, switch 24 is adjacent edge 30 joining the surfaces 26, 28. The switch 24 may be aligned with light source 22 along the edge 30. In this way, when the switch 24 is operated the light source 22 will generally be aimed toward whatever object is to be illuminated.

As shown in FIG. 3, the switch 24 may not be aligned with light source 22 along edge 30. However, it is preferred for switch and light source 22 to be relatively close to each other, as is shown in all three embodiments.

FIG. 4 is illustrates as preferred electric circuit. The audio player 10 has a compartment 27 for accommodating therein a source of electrical energy 29 such as, for example, a battery, a rechargeable battery, an adapter connected to the audio player 10, or the like. The energy source 29 is used to provide energy to illuminate light source 22 as well as for the audio player audio system including (but not limited to): control circuits 32, rewritable data memory 34 for storing digital media tracks, audio output 16, switch controller 36, and other functions 38. The energy source 28 is operatively connected to light source 22 by electrical lines 30.

The switch 24 is in line(s) 30 to control the operation of light source 22. The switch 24 may be a mechanical sliding switch with two separate positions for on and off; a push switch with two states—on and off; or a momentary switch that is on only when pressed. An electronic circuit 26 with a latching function may be provided so that switch 24 can be at momentary switch that operates with the latching function such that pressing the switch 24 once will turn on the light source 22, and pressing the switch 24 a second time will turn off the light source 22.

If the voltage from energy source 29 is insufficient to provide sufficient potential to fully energize light source 22, a DC/DC converter 31 may be provided to increase the voltage to the required level. Conversely, if the voltage from energy source 29 is excessive for light source 22, a DC/DC converter 31 may decrease the voltage to the desired level. For example, battery 29 may be 1.5V and light source 22 may require 5V to operate.

Similarly, circuit 26 may include a voltage regulator to provide a relatively constant voltage to light source 22.

Whilst there has been described in the foregoing description preferred embodiments of the present invention, it will be understood by those skilled in the technology that many variations or modifications in details of design or construction may be made without departing from the present invention.

1. A memory-based audio player with illumination comprising:
(a) a casing;
(b) an audio system within the casing and being able to be powered by an energy source when the energy source is operatively connected to the audio system;
(c) a rewritable memory for storing digital media tracks;
(d) at least one light source mounted to a first wall of the casing and able to be energized by the energy source when the energy source is located within the audio player;
(e) a switch mounted to a second wall of the casing for controlling the energization of the light source by the energy source; and
(f) the audio system comprising an audio processor for playing media tracks stored in the rewritable memory; and an audio output coupled to the audio processor.

2. An audio player as claimed in claim 1, wherein the switch is mounted in a second wall of the casing, the first and second walls being different and intersecting at an edge.

3. An audio player as claimed in claim 2, wherein the switch is adjacent the edge.

4. An audio player as claimed in claim 2, wherein the switch is aligned with the light source along the edge.

5. An audio player as claimed in claim 3 wherein the switch is aligned with the light source along the edge.

6. An audio player as claimed in claim 1, further comprising an electronic circuit with a latching function, the switch being a momentary switch.

7. An audio player as claimed in claim 6, the electronic circuit further comprising a DC/DC converter for converting a voltage as supplied by the energy source.

8. An audio player as claimed in claim 6, wherein the first wall and the second wall are different and intersect at an edge, the switch being aligned with the light source along the edge.

9. An audio player as claimed in claim 1, the light source being mounted in an opening of the first wall, the opening also being for restricting an included angle of emission of light from the light source.

10. An audio-player as claimed in claim 1, wherein the light source is a light emitting diode.

11. An audio-player as claimed in claim 1, wherein the light emitting diode is for the emission of white light.

12. An audio-player as claimed in claim 1, wherein the energy source comprises a battery receivable in a compartment located within the casing.

13. An audio-player as claimed in claim 12, wherein the audio player is a portable MP3 player.
